(19) United States
(12) Patent Application Publication
(10) Pub. No.: US 2015/0134497 A1
(43) Pub. Date: May 14, 2015

(54) METHOD FOR ASSISTING IN LOCATING AN ITEM IN A STORAGE LOCATION

(71) Applicants: Joshua Carney, Mölndal (SE); Henrik Carlén, Västra Frölunda (SE)

(72) Inventors: Joshua Carney, Mölndal (SE); Henrik Carlén, Västra Frölunda (SE)

(73) Assignee: SCA Hygiene Products AB, Göteborg (SE)

(21) Appl. No.: 14/384,402

(22) PCT Filed: Mar. 15, 2012
(86) PCT No.: PCT/SE2012/050290

§ 371 Date: Sep. 11, 2014

(51) Int. Cl. G06Q 10/08

(52) U.S. Cl. CPC G06Q 10/087
USPC 705/28

(57) ABSTRACT

A method for assisting in locating the occurrence of at least one item in a storage location, comprising at least the following steps, performed by a mobile device includes an image capturing device: capturing at least one image or video sequence or live video feed representing the storage location by means of the image capturing device; recognizing any occurrence of the item within the field of view of the image capturing device; and presenting information related to the location of the item.

### TECHNICAL FIELD

The present invention relates to a method for assisting in locating the occurrence of at least one item in a storage location. The invention also relates to a computer program for assisting in locating at least one item in a storage location and a mobile device for assisting in locating at least one item in a storage location.

### BACKGROUND

Today, is it common that shops such as retail markets, supermarkets and other stores sell a large variety of products and goods which are arranged and put on display on shelves forming aisles in said shops.

Large supermarkets, in particular, may offer a very large number of different products from different suppliers. For this reason, it can sometimes be very difficult for the consumer to locate a certain desired product in such a vast selection of products on display.

In particular, in some areas and for certain types of goods, it can also be difficult for a consumer in a supermarket, for example, to actually distinguish between different, but similar, products within a particular product category. Consequently, the consumer would then face two problems; firstly, finding the actual location of a particular product type in a supermarket environment or similar; and secondly, being able to actually distinguish between different products from different manufacturers and suppliers from within each product category.

One particular field of products in which it can be particularly difficult for a consumer to actually locate a particular desired product is the field of hygiene products, especially in the form of absorbent articles. Such articles are marketed in the form of feminine hygiene products such as sanitary napkins, or alternatively baby products such as diapers, or alternatively incontinence products for both women and men. All these types of products can, at first sight, be quite similar in the way they are packaged, marketed and sold. The product names of absorbent hygiene products can also be difficult to distinguish from one another. Also, all these types of products may be positioned in generally the same area of a supermarket, for example.

In summary, a consumer of an absorbent product may be faced with a vast range of manufacturers and types of products. All these products may come in similarly designed packages and with similar product names, which can be confusing for the consumer.

Consequently, the assortment of products within this field may appear to be complicated and difficult to comprehend for the customer. Also, absorbent hygiene products may sometimes also suffer from “poor shelf placement”, which means that they may be placed on shelves (in a shop or supermarket) which are not easy to find, or that they may be placed in position in which they will not get the customer's immediate attention.

In summary, it is understood that it is difficult for the consumer to understand and grasp the whole range of hygiene products being on the market today.

It is previously known to use modern computer-based systems for assisting a user, for example a customer in a supermarket, in finding a particular product. The patent document US 2010/0013662, for example, relates to a product locating system using RFID devices which are positioned on a particular product or on a shelf on which the product is positioned. The customer can enter information regarding a product description on a fixed computer terminal in the supermarket and the RFID device will subsequently return a signal to the computer terminal which indicates the position of the product in question.

Furthermore, the patent document US 2012/0023034 discloses a system for locating merchandise in a store, wherein the products in the store are provided with location indicators. The customers in the store may find the products by accessing a database in which information regarding the location of the products are stored.

Although the above-mentioned systems and methods are related to aiding a user such as a customer in a store in finding desired products, they are unnecessarily complex and can be perceived as difficult to use for the customer. Consequently, there is a need for improved systems and methods which are easy to use and which gives clear and useful information for assisting a customer in locating items such as products in a supermarket or similar storage location.

### SUMMARY OF THE INVENTION

Consequently, it is an object of the present invention to solve the above-mentioned problem and to provide a method which can be used to assist for example the user of a particular product, for example an absorbent product, in order to locate such a product in a storage location, for example a supermarket, a warehouse or similar.

In particular, it is an object of the present invention to provide a method and device which are easy to use and which can give a user clear information on a mobile device regarding the location of the desired product in said storage location.

Yet another object of the invention is to provide a method that facilitates, for users of a product, such as an absorbent hygiene product, to retrieve product-related information in addition to finding the location of said product.

These and other objects are achieved by a method for assisting in locating the occurrence of at least one item in a storage location, comprising at least the following steps, performed by a mobile device comprising an image capturing device: capturing at least one image or video sequence or live video feed representing said storage location by means of said image capturing device, recognizing any occurrence of said item within the field of view of said image capturing device; and presenting information related to the location of said item.

The invention relies on the insight that a mobile device, provided with an image capturing device such as a conventional camera provided on a mobile device (for example a mobile telephone) could be used to scan at least a certain section of the storage space in order to capture an image or a video sequence of a storage location in which it is believed that the product is located.

Furthermore, the mobile device contains suitable software for recognizing whether the desired product is located within the field of scan of the camera. This can be obtained through the use of image analysis of the captured image or video sequence, wherein the graphical representation of the product can be detected and identified by the software. If the product is identified, the software will preferably indicate this immediately to the user of the mobile device, by including suitable information on the display of the mobile device.

It should be noted that the captured image or images could be in the form of one or more single images, a recorded video sequence or a live video feed, i.e. a live streaming video sequence.

Due to the fact that a mobile device can be used to present information related to said product, the user may obtain such information—i.e. in addition to information allowing the user to find the actual location of the product—in order to select a suitable product. Such information can reflect the properties, price or quality of the product. Such product-related information can be provided by visual, aural, tactile or otherwise physical means, or any combination of such means, on the mobile device, and/or a communication device to which the mobile device is communicatively connectable, e.g. another mobile device.

The use of a mobile device comprising an image capturing device, such as a mobile phone, a so-called smartphone, a personal digital assistant (PDA), a tablet computer or the like, makes the method readily available to anyone in possession of such a mobile device.

The method is performed by the mobile device through execution of a computer program, which, in a preferred embodiment, is realised in form of an application program (hereinafter referred to as an “App”, or “application”, which consequently is used here to describe a piece of software designed to help a user of a mobile device to carry out specific tasks). The App is suitably arranged to be downloadable to a storage medium of the mobile device.

By allowing the method to be performed through the execution of an App that may be downloaded into existing mobile devices, the method becomes readily available to any user.

In order to perform the method, the mobile device is suitably positioned by a user in a position where it can be used for scanning at least a section of a storage space in which the desired product can be expected to be located.

Preferably, the image capturing device is a camera which is sensitive enough to register images of relatively high resolution.

The results of the image capturing step may be more reliable if a high-resolution camera is used and also if the mobile device is held steadily at a suitable distance to the used absorbent product.

In summary, this means that a clear indication regarding the location, and optionally also the properties, of a desired product can be provided to the user via the mobile device's graphical user interface during the actual scanning of the storage space.

Furthermore, the invention suitably makes use of a light source which for this purpose is integrated within the mobile device. Such is the case of conventional mobile telephones, which use a light source used for photographing where natural light conditions are insufficient. Consequently, the invention suitably comprises a step of illuminating the storage location with an integrated light source of the mobile device during the image capturing stage. Alternatively, the invention could be used for capturing images with the aid of a separate light source, i.e. it does not have to be an integrated part of the mobile device.

The image capturing can be carried out in at least two ways; the image capturing device can be used either for capturing one single image of the product; or the image capturing device can be used for obtaining a video, or multiple-image, sequence of images while scanning, or swiping, the mobile device along the storage location. Both these types of methods enable the user to input image information into the software of the mobile device in order to allow a processor of the mobile device to determine where the product in question is located.

As indicated above, the method may be a computer-implemented method performed by a mobile device through execution of a computer program. Thus, according to another aspect of the invention there is provided a computer program for assisting in locating at least one item in a storage location. When executed by a microprocessor, the computer program is configured to perform a method as described above. The invention also provides a computer program product comprising a non-volatile memory for storing computer-readable instructions, wherein the above mentioned computer program is encoded on said non-volatile memory.

Furthermore, the invention relates to a mobile device for assisting a user in locating a product in a storage location, which mobile device comprises an image capturing device, a processor and a storage medium for storing computer programs executable by said processor. Also, the storage medium stores the above mentioned computer program

The product in question, for example an item which a user of the invention can be expected to search for in the storage location—which for example can be a supermarket—can be of generally any kind, size, design and appearance as long as it is positioned in the storage space so that it can be captured by the image capturing device of the mobile device.

It should be noted that the invention is for example suitable to be used in connection with products in the form of hygiene products such as absorbent products as mentioned above. Such absorbent products can be any form of absorbent personal hygiene article, such as a male or female incontinence protector, a sanitary pad, a panty liner or a diaper, for example a diaper with tape fastener, a pant diaper or a belted diaper. Said hygiene products can also be constituted by lotions, wipes or towels, for example paper towels for hygiene use.

### BRIEF DESCRIPTION OF THE DRAWINGS

The invention will be described below with reference to an embodiment and the appended drawings, in which:

FIG. 1 illustrates a storage location which is of the type which can be found in a supermarket or a similar environment, wherein a user of the present invention is located;

FIG. 2 illustrates a mobile device and the storage location regarded from another angle as compared with FIG. 1 and showing the method according to the invention; and

FIGS. 3a, 3b and 3c show a mobile device in which the invention is used, in different stages of operation of the invention.

### DETAILED DESCRIPTION

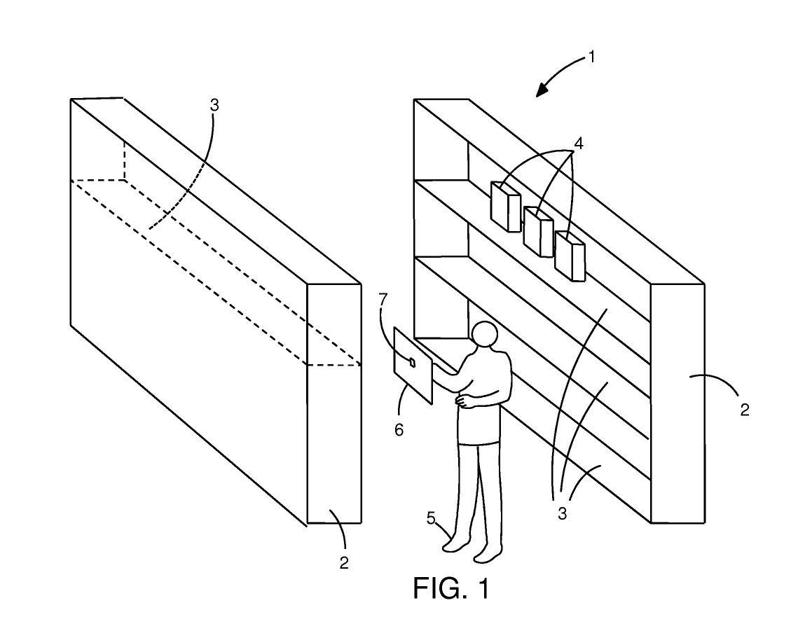

FIG. 1 illustrates a storage location 1 for a number of different products, such as a space which is to be found in a supermarket, a warehouse, a shop, a library or a similar type of environment. The storage location 1 comprises a number of storage devices 2 which according to the embodiment is based on a number of shelves 3 on which a number of items in the form of marketed products 4 are located.

Also, FIG. 1 shows a user 5 of the present invention, i.e. a person who is equipped with a mobile device 6. As will be explained in detail below, the mobile device 6 is arranged so as to be able to execute the present invention. The mobile device 6 shown in FIG. 1 is in the form of a so-called tablet computer, but it should be appreciated that any type of mobile device, such as a mobile phone, a personal digital assistant (PDA), a so-called smartphone or similar may be used to perform the invention.

The mobile device 6 comprises an integrated image capturing device 7 for capturing images and video recordings, to be subsequently stored in the mobile device 6. It should be noted here that the invention is not limited to a method in which the information regarding said images and video recordings are stored in the mobile device 6 only, but can also be implemented in a manner in which the captured images and video sequences are transmitted to a remote computer (not shown in the drawings) for further analysis remote from the mobile device 6 and the user 5.

An image capturing devices 7 as mentioned above is generally known and typically comprises an image sensor and a lens (not shown) which are used for example in mobile telephones and tablet computers for capturing photographic images and video sequences.

Although not shown in detail in the drawings, the mobile device 6 comprises a processor for processing data. The data may be received from communication devices to which the mobile device 6 is communicatively connectable via a network, or stored on a digital storage medium of the mobile device, which storage medium is accessible by said processor.

Consequently, the mobile device 6 carries a computer program which is stored in the storage medium and, when executed by the processor, causes the mobile device 6 to perform the method according to the invention, as will be described below.

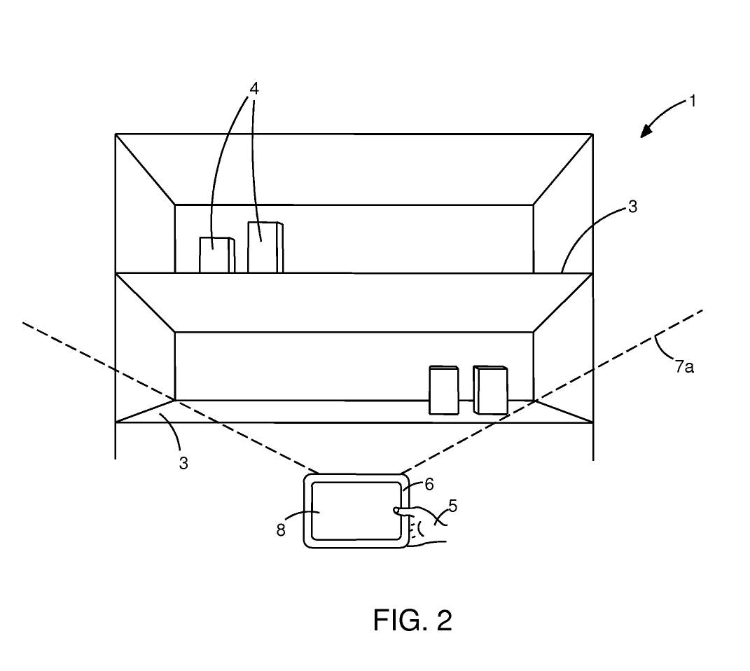

FIG. 2 shows a mobile device 6 as regarded from a different angle, i.e. an angle as seen from the perspective of the user 5 when facing a set of shelves 3 in the storage location 1. As indicated in FIG. 2, the mobile device 6 according to the embodiment comprises a display 8 for displaying information to the user 5, and, if realised in form of a so-called touch display, also for receiving information from the user 5 in form of user input. The mobile device 6 may also comprise other means for receiving user input, such as buttons, microphones, as well as means for outputting signals and information, such as for example a loudspeaker, a vibratory device etc. Such additional devices are generally known and for this reason they are not explained in detail here.

Consequently, according to the embodiment, the display 8 constitutes a user interface for inputting information and instructions from the user 5. As will be explained below, the display 8 preferably also constitutes a means for displaying visual information relating to the location of a desired product or other relevant information regarding the product, such as its price, properties or size.

The mobile device 6 is operable to perform all method steps of the inventive method, which method steps will be described in more detail below, through execution of a computer program stored in the storage medium.

Preferably, the computer program is realised in form of a stand-alone application, meaning that no data has to be received from external devices in order to run the program. However, the computer program may also be a client application of a distributed software solution further comprising a server-side application residing in an application server to which the mobile device is communicatively connectable. In this case, some of the method steps described below may be performed by the application server through execution of the server-side application.

In a preferred embodiment of the invention, the computer program stored on the mobile device 6 is realised in form of an App (or “application program”) which is downloadable into the storage medium from a downloading server to which the mobile device 6 is connectable. The App is preferably adapted to the Apple iOS platform and/or the Android platform and distributed through known distribution channels.

It should thus be appreciated that the “App” hereinafter refers to a computer program stored on the storage medium of the mobile device 6. As indicated in a simplified form in FIG. 2, the App can be executed by means of a suitable user input, for example in the form of a particular icon 9 on the display 8 which the user touches and which in this embodiment corresponds to a “start button” for the App.

Furthermore, in accordance with an embodiment of the invention, the App comprises displaying a number of further user input icons such a first series of icons in the form of product icons 10 which are used in order for the user 5 to select which product the user 5 wishes to find in the storage location 1. i.e. a selection between products, or items, A, B or C.

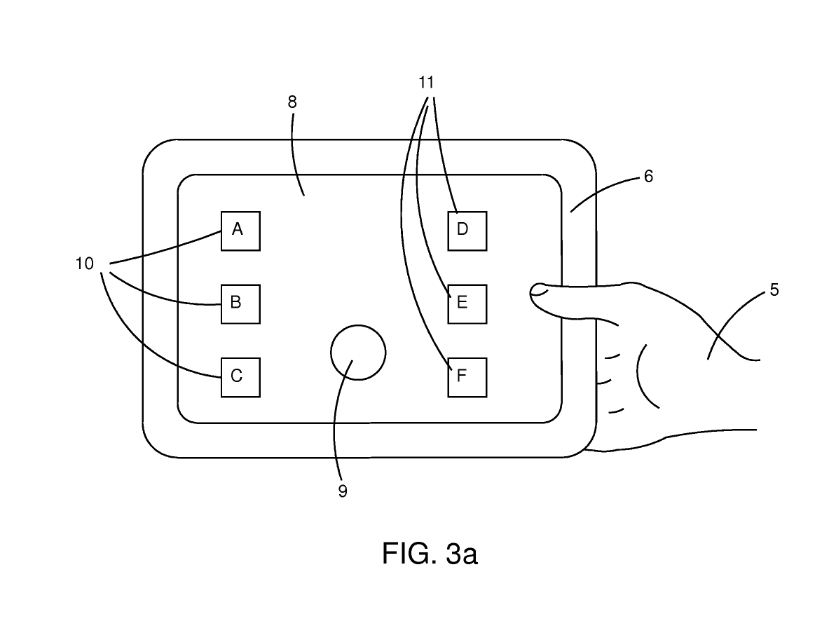

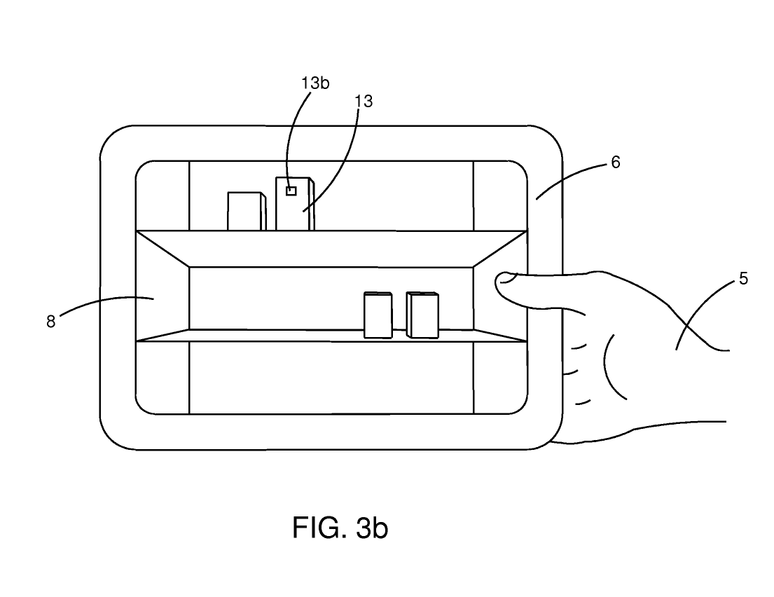

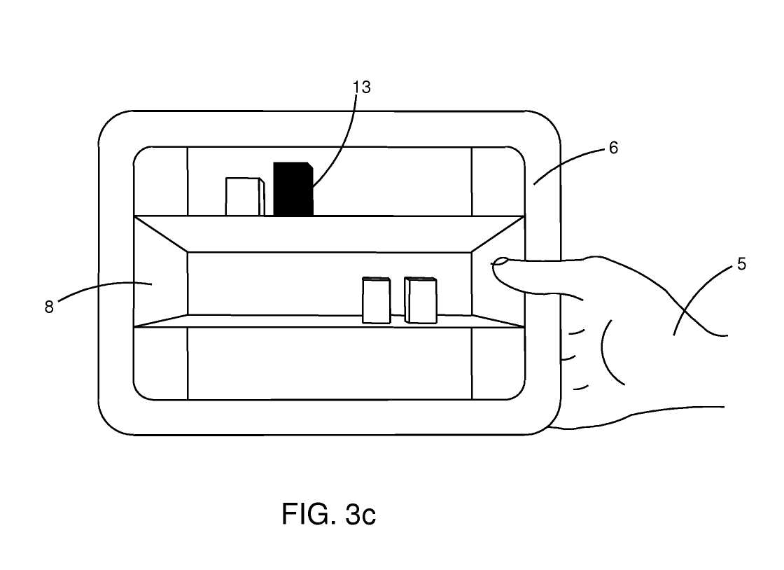

The icons 10 representing items A, B and C can for example be said to represent a particular product category, for example incontinence pads. The mobile device 6 can furthermore be arranged for allowing the user 5 to select an item from a further product category, for example baby diapers, For this reason, the App according to the invention can be arranged to present a second series of icons 11 on the display 8 corresponding to said further product category. As indicated in FIG. 3a, the user 5 may then select between different items representing different product types.

In accordance with the embodiment, the App in the mobile device 6 is initiated when the user 9 touches the “start” icon 9 shown in FIG. 3a. When this occurs, the App will enter a mode in which the image capturing device (not visible from the view in FIG. 3a) starts capturing a series of images, suitably in the form of a video sequence, displaying at least a part of the storage space 1. With reference to FIG. 3b, the display 8 of the mobile device 6 is then showing a corresponding picture, suitably in the form of a live feed of said video sequence, of the storage location 1.

Preferably, the image capturing device 7 s in the form of a camera and is positioned on the rear side of the mobile device 6. However, the invention is not limited to such placement only, i.e. the image capturing device 7 could for example be placed on the top surface or along the side edge of the mobile device 1.

As indicated in a simplified manner in FIG. 2, the image capturing device is arranged for capturing the pictures or video sequence within a particular image capturing angle 7a.

At this stage, the user 5 may use the mobile device 6 to sweep along the storage location 1 as if to “search for” a particular desired product. In other words, user 5 will direct the mobile device 6 towards a position on a shelf 3 or in a section of the storage location 1 where the particular desired product can be expected to be found. In FIG. 3b, such a desired product is indicated by means of reference numeral 13. Furthermore, this product 13 is provided with a particular recognition graphic 13b which can be recognized by means of image processing software in the mobile device 6.

In accordance with the embodiment, and in order to recognize the desired product, the mobile device 6 is arranged for capturing and analyzing the pictures or video sequences through image recognition, according to principles which are well known to the skilled person and which for this reason are not described in detail here.

In accordance with the embodiment, the mobile device 6 is particularly adapted for recognizing a graphic representation of the desired product 13. Such recognition can be based on an image analysis of the design of the product packaging, wholly or in part, with regard to its shape, design, colour, pattern or particular features printed or otherwise applied to the product packaging. The mobile device 6 can be adapted to recognize the entire product 13 or a part thereof.

Consequently, a particular part, shape, marking or design of the product 13—which can be referred to as a recognition graphic—can be detected, analyzed and recognized by means of the mobile device 6. This recognition graphic is indicated schematically in FIG. 3b by means of reference numeral 13b.

The App according to the invention is consequently arranged for image recognition of such type that the recognition graphic 13b of the product 13 is recognized and when this occurs, an image or suitable graphical representation of the product 13 is shown on the display 8 in a manner so that the user can easily distinguish it from the other products shown on the display 8. For example, the software in the mobile device 6 can be arranged so that the desired product 13 is shown having its outline or contour of the product 13 shown in a suitable colour, for example red. In this manner, the product 13 in question can be easily detected on the display 8. This is shown in FIG. 3c. The graphical representation of the product 13 is suitably shown superimposed onto the displayed image or video sequence on said display 8, in a position corresponding to the photographic image or video sequence of the product 13.

It should be noted that information regarding the exact position of the product 13 is not required, just information regarding the location of the product 13 in relation to the mobile device 6.

The information relating to the location of the product 13 can also be in the form of aural information such as for example sound effects or spoken messages or in the form of tactile or some other type of information indicated by physical means such as vibrations, or a combination of visual, aural, tactile or other physical information.

The invention is not limited to the above-mentioned image recognition only, but can be realized in alternative ways, for example through the use of NFC (Near Field Recognition) tags, transponders, QR codes or other devices or markings which allow the mobile device 6 with its image capturing device 7 to determine the location of the product 13 in question and to present information related to said location to a user 5.

Furthermore, the invention can optionally be arranged so that product-related information regarding the product 13 in question is also presented to the user 5. In such case, said product-related information can be constituted by information related to the price, contents, properties or handling of the product 13.

The information presented to the user 5 can also be constituted by information not relating to the actual product 13 but to some other related factors, such as information regarding ongoing sales or information regarding similar products.

Furthermore, the invention can optionally be arranged so that the user 5 makes a selection of one or more desired products after the actual image scanning and image recognition has been concluded. For example, the user 5 may instruct the mobile device to start scanning a particular storage location 1 where it can be expected that a number of products, which may or may not be of interest to the user 5, are located. If and when the mobile device 6 recognizes the occurrence of one or more desired products, information relating to these products are shown on the display 8.

Furthermore, the mobile device 6 can be provided with a set of information in the form of a “shopping list”, i.e. a number of products which the user 5 wishes to purchase. When the user 5 uses the mobile device 6 to scan the storage location 1 in the supermarket, the mobile device will 6 recognize and show on the display 8 any item from such a shopping list. In this case, the mobile device 6 is arranged for finding more than one product simultaneously.

Furthermore, the mobile device 1 preferably comprises a light source (not shown in the drawings) which can be a conventional flash-type light device as used in many of today's mobile devices such as mobile telephones. The light source is arranged for generating a field of light (not shown in the drawings) directed from the mobile device 6. Alternatively, the invention could be used with a separate light source or with natural ambient light only, if the light conditions are sufficient.

Furthermore, and although not shown in the drawings, it should be noted that the mobile device could be in the form of an autonomous vehicle or similar carrier of an image capturing device. Such an autonomous carrier could be programmed to follow a path within a storage location while capturing images (i.e. one or more single images, a video sequence or a live video feed). These images could then be used in accordance with the principles of this invention in order to assist in locating an item within said storage location.

The invention is particularly suitable for absorbent products but is not limited to such products only, but can be used generally for all sorts of merchandise and goods as long as they are positioned in the storage space 1 and can be captured by the image capturing device 7.

In case that the product is a hygiene product, the invention can be used with all types of hygiene products such as absorbent products in the form of male or female incontinence pad, a sanitary pad or a diaper, for example a diaper with tape fastener, a pant diaper or a belted diaper. The invention can also be used with other types of hygiene products such as lotion, wipes or towels.

As an optional additional step, the mobile device 6 can suitably be arranged to provide item-related, or product-related, information regarding the product 13 and to show such information on the display 8. Examples of such product-related information is the size, price or contents of the product 13, or for example a manual of operation for the product 13.

Obviously, the processor may be adapted for displaying a variety of information on the display 8. For the normal user it can be assumed that the most helpful information to be displayed is information directly related to suggestions on how to use the product 13. In this manner, the invention can be used in a highly user-friendly manner.

The invention is not limited to the embodiments described above, but can be varied within the scope of the subsequent claims.

For example, the mobile device 6 may use an built-in accelerometer, gyro or gyroscope device (not shown) in order to sense the acceleration or orientation of the mobile device 6. Such a device can be used for inputting commands from the user 5. For example, the user 5 can then initiate a search for a desired product 13 (instead of tapping on the “start” icon 9 mentioned above) by shaking the mobile device 6. An accelerometer or gyroscope is then used to detect this shaking movement in order to trigger the start of the image capturing process according to the embodiment.

Furthermore, as mentioned above, the mobile device is suitably in the form of a tablet computer, a mobile phone or the like, but could alternatively be constituted by an autonomous mobile device carrying an image capturing device and being arranged for scanning the storage location in order to locate one or more desired items in said storage location.

Furthermore, it is not necessary to analyze the contents of the captured image or video sequence at the same time that the image or video sequence is actually shown on the display. For example, the captured images can be transferred to a remote computer and be analyzed at a suitable point in time.

1. A method for assisting in locating the occurrence of at least one item in a storage location, comprising at least the following steps, performed by a mobile device comprising an image capturing device:
receiving input information from a user regarding said item to be located;
capturing at least one image or video sequence or live video feed representing said storage location by means of said image capturing device),
recognizing any occurrence of said item within the field of view of said image capturing device by identifying the item in said field of view and through the use of a recognition graphic in the form of a design, print, marking, code or similar applied to the item or its packaging; and
presenting information related to the location of said item.

2. A method according to claim 1, comprising presenting said information related to the location of said item to a user of said mobile device on a display forming part of said mobile device.

3. A method according to claim 2, comprising:
displaying said image or video sequence or live video feed on said display; and
superimposing a graphical representation of said information related to the location of said item onto the displayed image or video sequence on said display, thereby presenting information related to the location of said item on said mobile device.

4. A method according to claim 2, comprising presenting item-related information regarding said item on said display.

5. A method according to claim 4, wherein said item-related information is constituted by information related to the price, contents, properties or handling of said item.

6. A method according to claim 2, comprising receiving input information from said user corresponding to selecting said item.

7. A method according to claim 6, comprising a step of selecting said at least one type of desired product after said image or video sequence or live video feed is analysed.

8. A method according to claim 1, comprising the step of illuminating at least a part of the storage location in which the item is expected to be located with a light source.

9. A method according to claim 1, wherein said step of recognizing any occurrence of said item is combined with an output signal of aural, tactile, vibratory or other physical type.

10. A method according to claim 1, wherein the item is a hygiene article, such as a male or female incontinence protector, a sanitary pad, a diaper with tape fastener, a pant diaper or a belted diaper; a lotion, wipe or towel.

11. A computer program for assisting in locating at least one item in a storage location, wherein the computer program, when executed by a processor of a mobile device comprising an image capturing device, causes the mobile device to perform the method according to claim 1.

12. A mobile device for assisting in locating at least one item in a storage location, the mobile device comprising an image capturing device, a processor, and a storage medium for storing computer programs executable by said processor, wherein the storage medium stores a computer program according to claim 11.

13. A mobile device according to claim 12, wherein it is constituted by a tablet computer, a mobile phone, a personal digital assistant (PDA), a smartphone or similar.
